(19) United States
(12) Patent Application Publication
(10) Pub. No.: US 2013/0100992 A1
(43) Pub. Date: Apr. 25, 2013

(54) APPARATUS AND METHOD FOR PROVIDING MULTI-ANTENNA SCHEME IN WIRELESS COMMUNICATION SYSTEM

(71) Applicant: Samsung Electronics Co., Ltd., Gyeonggi-do (KR)

(72) Inventors: Gyu-Bok PARK, Gyeonggi-do (KR); Se-Hyun PARK, Gyeonggi-do (KR); Austin KIM, Gyeonggi-do (KR); Joon-Ho Byun, Gyeonggi-do (KR)

(73) Assignee: SAMSUNG ELECTRONICS CO., LTD., Gyeonggi-do (KR)

(21) Appl. No.: 13/657,204

(22) Filed: Oct. 22, 2012

(30) Foreign Application Priority Data
Oct. 25, 2011 (KR) 10-2011-0109381

(51) Int. Cl. H04B 7/02; H04W 88/02

(52) U.S. Cl. 375/219; 375/267

(57) ABSTRACT

Provided are an apparatus and method for providing a multi-antenna scheme in a wireless communication system by using a plurality of terminals. In a downlink receiving scheme at a mobile terminal, a terminal group is established comprising the mobile terminal and at least one adjacent terminal The mobile terminal receives a first signal from a base station, and at least one second signal through a short-range communication network from the at least one adjacent terminal The at least one second signal is representative of the first signal transmitted from the base station as received at the at least one adjacent terminal A received signal is detected as an antenna array signal on the basis of the first and at least one second signals. A similar scheme may be used for uplink transmissions, in which a virtual antenna array is established with a terminal group for transmitting uplink.

### CLAIM OF PRIORITY

This application claims priority under 35 U.S.C. §119 to an application filed in the Korean Intellectual Property Office on Oct. 25, 2011 and assigned Serial No. 10-2011-0109381, the contents of which are incorporated herein by reference.

### BACKGROUND

1. Technical Field

This disclosure relates generally to an apparatus and method for providing a multi-antenna scheme in a wireless communication system.

2. Description of the Related Art

Due to the rapid development of the wireless mobile communication market, various multimedia services are available in wireless environments. As the amount of transmission data and data transmission rates increase in order to provide multimedia services, an interest in a multi-antenna scheme for efficient use of limited frequencies is rapidly increasing.

In one conventional multi-antenna scheme, a base station (BS) and a terminal each includes a plurality of antennas. The base station and the terminal transmit data of a single data communication session through independent space channels via multi-antenna scheme, thereby increasing transmission reliability and a transmission rate as compared to a single-antenna transmission scheme, even without additional frequencies and transmission power.

However, due to its limited space, the handheld mobile terminal has a limitation in including a plurality of antennas; thus the benefits of conventional multi-antenna schemes have been limited.

### SUMMARY

Aspects of the present disclosure are to substantially solve at least the above problems and/or disadvantages and to provide at least the advantages below. Accordingly, an aspect of the present disclosure is to provide an apparatus and method for providing a multi-antenna scheme in a wireless communication system by using a plurality of terminals.

Another aspect of the present disclosure is to provide an apparatus and method for providing a multi-antenna scheme in a wireless communication system by using one or more adjacent terminals.

Yet another aspect of the present disclosure is to provide an apparatus and method for transmitting a signal from a base station with a plurality of antennas to a host terminal according to a multi-antenna scheme using a plurality of terminals.

Still another aspect of the present disclosure is to provide an apparatus and method for transmitting a signal from a terminal to a base station according to a multi-antenna scheme using a plurality of terminals.

In an exemplary embodiment, a method for providing a multi-antenna scheme in a wireless communication system by using a plurality of terminals is provided. In a downlink receiving scheme at a mobile terminal, a terminal group is established comprising the mobile terminal and at least one adjacent terminal The mobile terminal receives a first signal from a base station, and at least one second signal through a short-range communication network from the at least one adjacent terminal. The at least one second signal is representative of the first signal transmitted from the base station as received at the at least one adjacent terminal. A received signal is detected as an antenna array signal on the basis of the first and at least one second signal, wherein at least one adjacent terminal previously receives at least one second signal transmitted from the base station based on information from the mobile terminal of a group in which the mobile terminal and the at least one adjacent terminal are grouped

According to another exemplary embodiment, an apparatus for receiving a signal by a mobile terminal with one or more antennas includes: a short-range communication module for communicating with one or more adjacent terminals through a short-range communication network; a receiving unit for receiving a signal from a base station; a transmitting unit for transmitting a signal to a base station; a group generating unit for generating a terminal group including one or more adjacent terminals by using the short-range communication module; and a control unit for transmitting information on the terminal group to a base station through the transmitting unit, and detecting a received signal by using a signal received from the base station through the receiving unit and a signal received through the short-range communication module from the one or more adjacent terminals included in the terminal group.

According to still another exemplary embodiment, a method for transmitting a signal by a mobile terminal with one or more antennas includes: generating a terminal group including one or more adjacent terminals; transmitting information on the terminal group to a base station; transmitting a signal destined for the base station through a short-range communication network to the one or more adjacent terminals included in the terminal group; and transmitting a signal to the base station when a signal transmission time point to the base station arrives.

According to yet another exemplary embodiment, an apparatus for transmitting a signal by a mobile terminal with one or more antennas includes: a short-range communication module for communicating with one or more adjacent terminals through a short-range communication network; a receiving unit for receiving a signal from the base station; a transmitting unit for transmitting a signal to a base station; a group generating unit for generating a terminal group including one or more adjacent terminals by using the short-range communication module; and a control unit for transmitting information on the terminal group to the base station through the transmitting unit, transmitting a signal destined for the base station through the short-range communication network to the one or more adjacent terminals included in the terminal group, and transmitting a signal to the base station when a signal transmission time point to the base station arrives.

According to a further exemplary embodiment, a method for transmitting a signal by a mobile terminal with one or more antennas includes: acquiring synchronization with a first terminal when receiving a signal destined for a base station from the first terminal through a short-range communication network; and transmitting the signal that is destined for the base station and is received from the first terminal to the base station, when a signal transmission time point to the base station arrives.

According to yet another exemplary embodiment, an apparatus for transmitting a signal by a mobile terminal with one or more antennas includes: a short-range communication module for communicating with one or more adjacent terminals through a short-range communication network; a transmitting unit for transmitting a signal to a base station; and a control unit for acquiring synchronization with a first terminal when receiving a signal destined for a base station from the first terminal by using the short-range communication module, and transmitting the signal that is destined for the base station and is received from the first terminal to the base station by using the transmitting unit, when a signal transmission time point to the base station arrives.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration for transmitting downlink (DL) data in a wireless communication system through a multi-antenna scheme according to an exemplary embodiment of the present invention;

FIG. 2 is a flow diagram illustrating a process for receiving a signal by a host terminal through a multi-antenna scheme according to an exemplary embodiment of the present invention;

FIG. 3 is a flow diagram illustrating a process for receiving a signal of a host terminal by a terminal according to an exemplary embodiment of the present invention;

FIG. 4 is a flow diagram illustrating a process for receiving a signal of a host terminal by a terminal according to another exemplary embodiment of the present invention;

FIG. 5 is a flow diagram illustrating a process for transmitting a signal by a base station according to an exemplary embodiment of the present invention;

FIG. 6 is a diagram illustrating a configuration for transmitting uplink (UL) data in a wireless communication system through a multi-antenna scheme according to an exemplary embodiment of the present invention;

FIG. 7 is a flow diagram illustrating a process for transmitting a signal by a host terminal through a multi-antenna scheme according to an exemplary embodiment of the present invention;

FIG. 8 is a flow diagram illustrating a process for transmitting a signal of a host terminal by a terminal according to an exemplary embodiment of the present invention;

FIG. 9 is a flow diagram illustrating a process for receiving a signal by a base station according to an exemplary embodiment of the present invention;

FIG. 10 is a block diagram illustrating a configuration of a terminal according to the present invention; and

FIG. 11 is a block diagram illustrating a configuration of a base station according to the present invention.

### DETAILED DESCRIPTION OF EXEMPLARY EMBODIMENTS

Exemplary embodiments of the present invention will be described herein below with reference to the accompanying drawings. In the following description, detailed descriptions of well-known functions or configurations will be omitted since they would unnecessarily obscure the subject matter of the present invention. Also, the terms used herein are defined according to the functions of the present invention. Thus, the terms may vary depending on users' or operators' intentions or practices. Therefore, the terms used herein should be understood based on the descriptions made herein.

The present invention relates to an apparatus and method for providing a multi-antenna scheme in a wireless communication system by using a plurality of terminals. Hereinafter, examples of a technology for providing a multi-antenna scheme in a wireless communication system by using a plurality of terminals will be set forth, according to the present invention. Herein, each terminal includes one or more antennas.

In the following description, a multiple-input multiple-output (MIMO) algorithm refers to an algorithm for detecting a signal transmitted through a plurality of antennas according to a multi-antenna scheme. For example, the MIMO algorithm can involve minimum mean square error (MMSE), maximum likelihood (ML), and /or zero forcing (ZFO) or other suitable techniques.

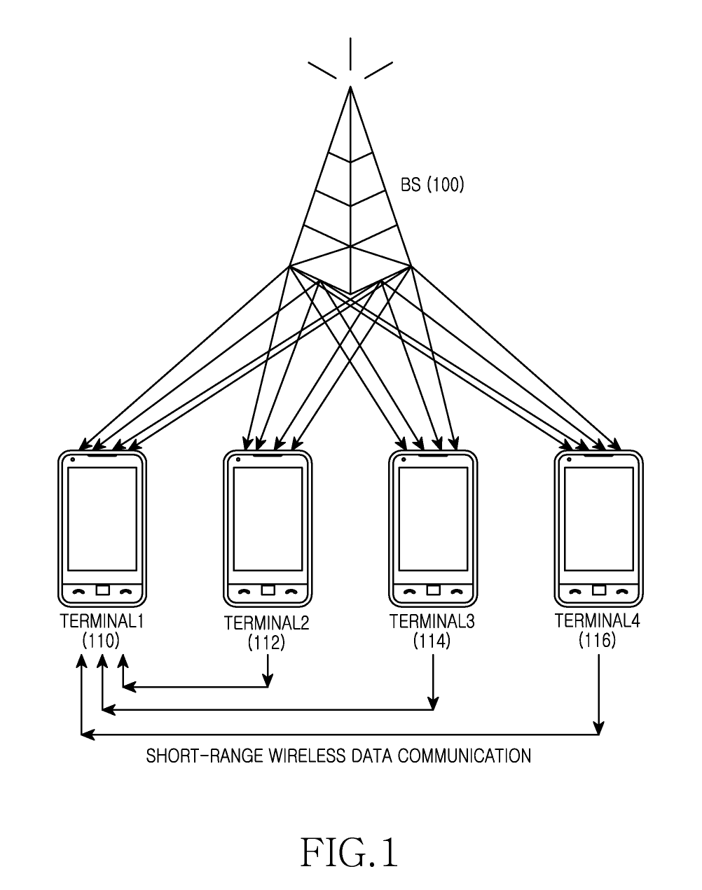

In the following description, the wireless communication system may transmit a downlink signal through a multi-antenna scheme using a plurality of terminals as illustrated in FIG. 1.

FIG. 1 illustrates a configuration for transmitting downlink (DL) data in a wireless communication system through a multi-antenna scheme according to an exemplary embodiment of the present invention. A first terminal 110 groups a second terminal 112, a third terminal 114, and a fourth terminal 116 into a terminal group for a multi-antenna service through a short-range communication network. While in this example the terminal group includes four terminals, a terminal group can have as little as two terminals in less complex implementations, or more than four terminals. A base station (BS) 100 transmits a signal destined for the first terminal 110 to the terminals 110, 112, 114 and 116 through a plurality of antennas or through one antenna. Herein, the short-range communication network may be any one of wireless LAN, WiGig, Bluetooth, UWB or any other suitable short range technology. The grouping for the multi-antenna service is established by the first terminal 110 via suitable requests sent to the other terminals and confirmed replies over predetermined short range channels. It is noted here that each of the terminals 110 to 116 can be any of a variety of wireless terminals capable of communicating with a base station and equipped with auxiliary short range communication capability, such as a smart phone, a tablet PC, a laptop, a personal digital assistant (PDA), an ebook, and the like. It will be apparent to one skilled in the art that if the terminals are of substantially the same or similar design and operate at the same wireless protocols, then establishing a virtual antenna array is facilitated.

A base station (BS) 100 transmits a first signal, e.g., a traffic channel or control channel data signal, destined for the first terminal 110. This first signal is received by the terminal 110 at its location, and is also received by the terminals 112, 114 and 116 at their respective locations, by means of the receivers within those terminals being tuned to receive the frequency of the first signal and using the same reception protocol as the first terminal 110.

Once the terminal group is defined, to achieve high accuracy in reception, the distances and orientations of the terminals 110, 112, 114 and 116 with respect to one another can be fixed to establish a virtual fixed antenna array. This can be achieved, e.g., by placing all the terminals in a suitable holding fixture (not shown) that provides uniform spacings between the terminals. Thus each terminal's antenna (or multiple antennas, if provided) becomes an antenna element in a virtual antenna array formed by the terminals of the group.

The second terminal 112, the third terminal 114, and the fourth terminal 116 each transmits a short range signal that is destined for the first terminal 110, through the short range communication network. The short range signal transmitted by an adjacent terminal such as 112 corresponds to the first signal received from the base station 100 at that adjacent terminal For example, second terminal 112 transmits a short range signal (second signal) containing information representing the amplitude and phase of the first (base station) signal received thereat. In other words, the second signal contains information of the first signal in the as-received state at the second terminal 112. The second signal from the second terminal 112 may be a digital or analog representation of the first signal received at the second terminal 112. Likewise, the other terminals 114 and 116 transmit respective second signals to the first terminal 110 representing the as-received states of the first signal as received at those terminals. In this case, the each adjacent terminal may transmit the signal without detecting from the base station in an encapsulated form according to the short range communication protocol to the first terminal 110.

As another example, the second terminal 112, the third terminal 114, and the fourth terminal 116 detect a signal that is transmitted by the base station 100 through each transmission (TX) antenna of the base station (for the case where the base station employs multiple TX antennas in a MIMO scheme), by applying a MIMO algorithm to a signal that is destined for the first terminal 110 and is received from the base station 100. Thereafter, the second terminal 112, the third terminal 114, and the fourth terminal 116 may transmit the signal detected through the MIMO algorithm to the first terminal 110. In this case, the second to fourth terminals 112 to 116 detect signals of different TX antennas. In this case, the each adjacent terminal may detect the signal received from the base station and then transmit the detected signal to the first terminal 110 in an encapsulated form according to the short range communication protocol.

The first terminal 110 acquires synchronization with the second terminal 112, the third terminal 114, and the fourth terminal 116 by exchanging signals with the second terminal 212, the third terminal 114, and the fourth terminal 116 through the short-range communication network. The synchronization is sufficient to establish a virtual antenna array without the necessity of connecting RF transmission lines between the terminals as in a conventional antenna array. This may be carried out using precise calibration between reference RF oscillators employed in the respective terminals 110, 112, 114 and 116. The reference RF oscillators of the terminals may be precisely synchronized to one another during a calibration process. By comparing the receive signals to essentially the same calibrated reference oscillator signals simultaneously, relative phase of the received base station signal between the terminals may be established. In other words, the phase of the receive signal at one terminal can be known relative to the phase of the same receive signal at the other terminals. A digital representation of the received first signal may then be transmitted from each adjacent terminal That is, samples of the amplitude and phase of the receive signal at terminals 112, 114 and 116 are immediately converted to a suitable format in the short range communication scheme and transmitted to the first terminal 110. For example, data communication at the short range communication may be done at a significantly higher bit rate than the bit rate of communication between the base station and the first terminal 110. Thus, communication delay is minimized and sufficient time is available to receive and process the representative short range signals. Alternatively, an analog representation may be transmitted.

Thus, the first terminal 110 detects a “virtual antenna array received signal” (hereafter, “composite received signal” or just “received signal”, interchangeably) on the basis of the first signal received from the base station 100 and the second signals received from the second terminal 212, the third terminal 114, and the fourth terminal 116 through the short-range communication network. For example, the first terminal 110 generates a received signal matrix by combining the first signal received from the base station 100 and the second signals received from the second through the terminals 112, 114 and 116, as if a signal is received through four reception (RX) antennas. Thereafter, the first terminal 110 may detect the received signal by applying the MIMO algorithm to the received signal matrix. It is noted that the distances between the first terminal 110 and second through the terminals 112, 114 and 116 are known and used in applying the MIMO algorithm.

In another implementation, the first terminal 110 detects a signal transmitted through any one of the TX antennas of the base station 100, by applying the MIMO algorithm to a signal received from the base station 100. Thereafter, the first terminal 110 detects a received signal by combining a detection signal received from each of the terminals 112, 114 and 116 and a signal detected by the first terminal 110. In this case, the second to fourth terminals 110 to 116 detect signals of different TX antennas.

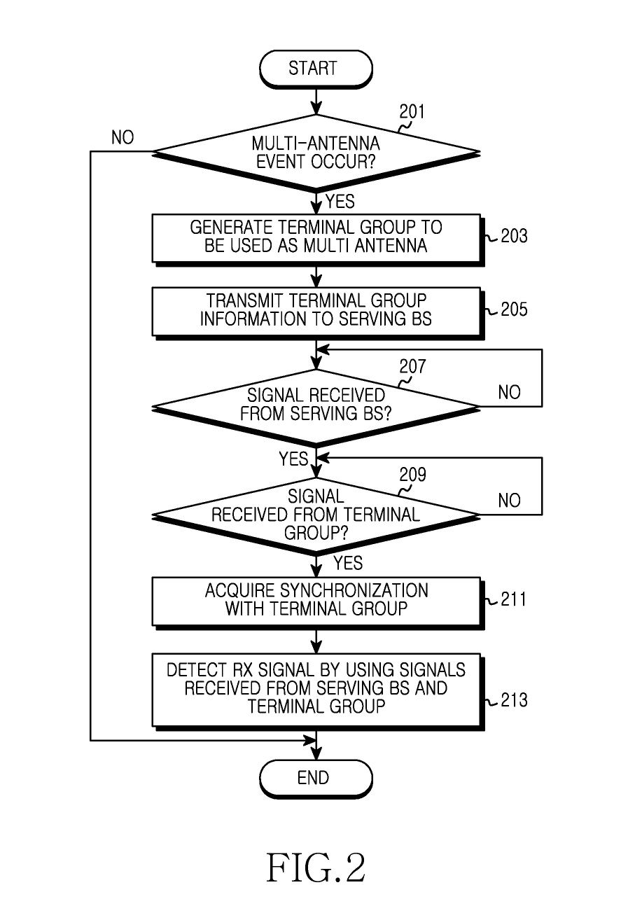

FIG. 2 illustrates a process for receiving a signal by a host terminal through a multi-antenna scheme according to an exemplary embodiment of the present invention. At step 201, the host terminal (such as terminal 110 of FIG. 1 operating as described above) determines whether a multi-antenna event occurs. For example, the host terminal determines whether a menu for a multi-antenna service is selected by a user. As another example, the host terminal determines whether an application program using a multi-antenna service is executed.

When a multi-antenna event does not occur, the host terminal determines that a multi-antenna service is not used. Accordingly, the host terminal ends the present algorithm.

On the other hand, when a multi-antenna event occurs, the host terminal at step 203 generates (establishes) a terminal group for use as an RX antenna. For example, when a multi-antenna event occurs, the host terminal uses a short-range communication network to detect whether there is an adjacent terminal to be used as an RX antenna. When detecting one or more adjacent terminals available as an RX antenna, the host terminal requests a multi-antenna service from the one or more adjacent terminals detected. As indicated earlier, the one or more adjacent terminals is preferably placed at a known, fixed distance and orientation in relation to the host terminal; where the host terminal is informed of the fixed distance in a suitable manner. The fixed distance may be predetermined by means of the terminals being placed in a predefined holding fixture separating terminals at predefined distances. Thereafter, the host terminal generates a terminal group so that one or more adjacent terminals accepting the multi-antenna service are used as an RX antenna. Herein, the adjacent terminals that can be used as an RX antenna by the host terminal include one or more terminals that are registered in the system for use in a multi-antenna service, among terminals located within a region capable of communicating signals with the host terminal through the short-range communication network.

In step 205, the host terminal transmits terminal group information to a serving BS. For example, the host terminal periodically transmits terminal group information to the serving BS. As another example, the host terminal may transmit terminal group information to the serving BS when a signal transmission/reception event occurs. Herein, the terminal group information includes identification information of adjacent terminals included in the terminal group.

In step 207, the host terminal determines whether a signal is received from the serving BS. If yes, then in step 209, the host terminal determines whether a signal is received through the short-range communication network from one or more adjacent terminals included in the terminal group.

When a signal is received from the adjacent terminal included in the terminal group, the host terminal proceeds to step 211. In step 211, the host terminal acquires synchronization with one or more adjacent terminals included in the terminal group. For example, the host terminal acquires synchronization with each adjacent terminal by exchanging synchronization signals with each adjacent terminal in the terminal group.

Thereafter, in step 213, the host terminal detects a received signal (virtual antenna array signal) by using a first signal received from the serving BS and second signals received through the short-range communication network from the adjacent terminals included in the terminal group. For example, the host terminal generates a received signal matrix by combining the first and second signals, as if a signal is received through a plurality of RX antennas. Thereafter, the host terminal may detect the received signal by applying a MIMO algorithm to the received signal matrix.

As another example, the host terminal detects a signal transmitted through any one of the TX antennas of the serving BS, by applying a MIMO algorithm to a signal received from the serving BS. Thereafter, the host terminal detects a received signal by combining a detection signal received from the adjacent terminal included in the terminal group and a signal detected by the host terminal

As described above, when a multi-antenna event occurs, the host terminal uses the short-range communication network to generate a terminal group for use as an RX antenna for a multi-antenna scheme. That is, a virtual antenna array is established for receiving. Thereafter, the host terminal may continuously update the terminal group by considering the states of adjacent terminals available as an RX antenna.

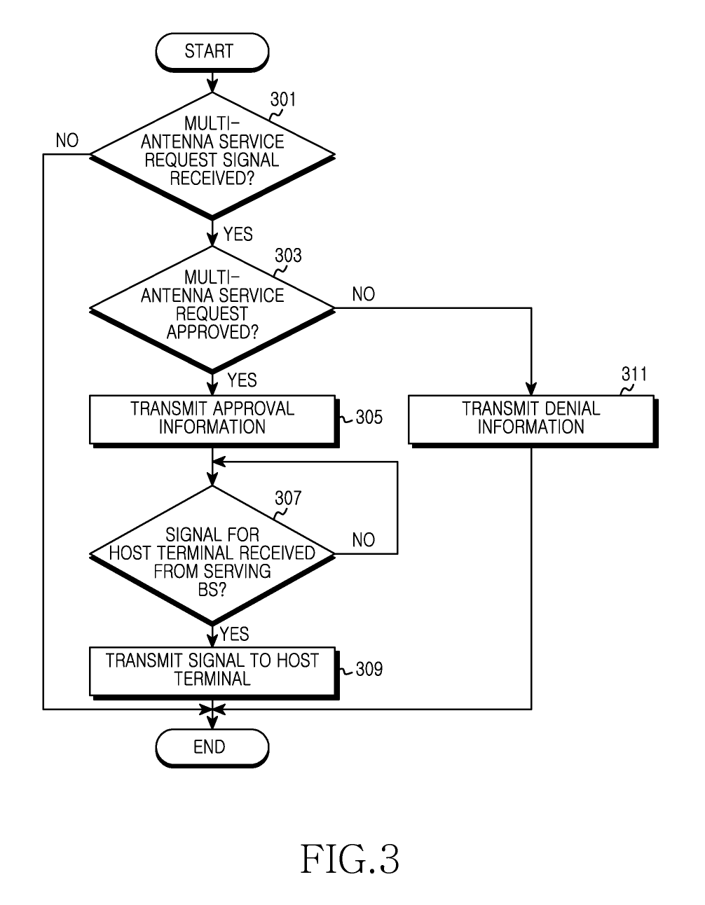

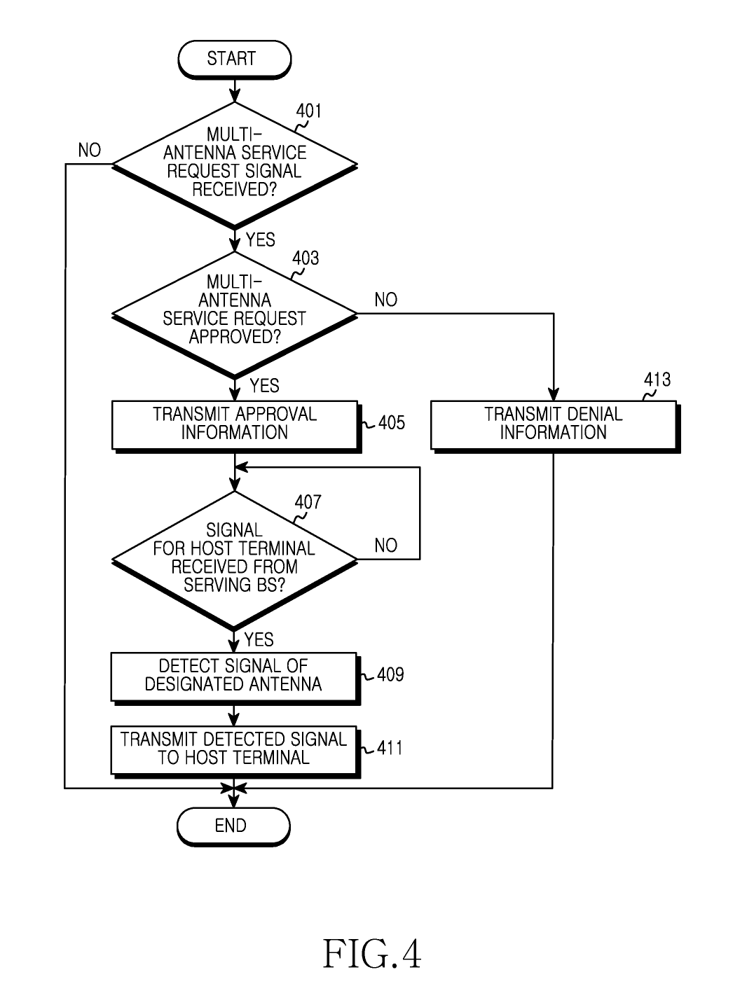

When the host terminal uses a multi-antenna scheme by using the second signals received from the adjacent terminals included in the terminal group as described above, the adjacent terminal operates as illustrated in FIG. 3 or 4.

FIG. 3 illustrates a process for receiving a signal of a host terminal by an adjacent terminal according to an exemplary embodiment of the present invention. In step 301, the adjacent terminal (hereafter, “the terminal”) determines whether a multi-antenna service request signal is received from the host terminal through a short-range communication network. Herein, the host terminal means any terminal requesting a multi-antenna service, among the terminals that are registered in the system so that antennas can be shared for a multi-antenna service.

When a multi-antenna service request signal is not received from the host terminal, the terminal determines that a multi-antenna service is not provided. Accordingly, the terminal ends the present algorithm.

On the other hand, when a multi-antenna service request signal is received from the host terminal, the terminal proceeds to step 303. In step 303, the terminal determines whether to approve a multi-antenna service request of the host terminal. For example, the terminal determines whether to approve a multi-antenna service request of the host terminal, based on at least one of the service load, communication state, and battery state of the terminal

When not approving a multi-antenna service request of the host terminal, the terminal proceeds to step 311. In step 311, the terminal transmits denial information on the multi-antenna service request to the host terminal

When approving a multi-antenna service request of the host terminal, the terminal proceeds to step 305 where the terminal transmits approval information on the multi-antenna service request to the host terminal In step 307, the terminal determines whether a signal of the host terminal is received from a serving BS. For example, when approving a multi-antenna service request of the host terminal, the terminal determines whether a signal of the host terminal is received through a communication link that is established with the serving BS in order to receive a signal of the host terminal.

When a signal of the host terminal is received from the serving BS, the terminal proceeds to step 309. In step 309, the terminal transmits a representation of the received BS signal to the host terminal through the short-range communication network. Herein, the terminal transmits its synchronization signal information and channel information with the serving BS to the host terminal together with the signal representing the BS signal received from the serving BS.

In the above embodiment, the terminal transmits a signal of the host terminal received from the serving BS to the host terminal without decoding the received signal.

In another exemplary embodiment, as illustrated in FIG. 4, the terminal may detect a signal transmitted through any one of the TX antennas of the serving BS from a signal of the host terminal received from the serving BS, and transmit the same to the host terminal

FIG. 4 illustrates a process for receiving a signal of a host terminal by an adjacent terminal according to another exemplary embodiment of the present invention. In step 401, the terminal determines whether a multi-antenna service request signal is received from the host terminal through a short-range communication network. Herein, the host terminal means any terminal requesting a multi-antenna service, among the terminals that are registered in the system so that antennas can be shared for a multi-antenna service.

When a multi-antenna service request signal is not received from the host terminal, the terminal determines that a multi-antenna service is not provided. Accordingly, the terminal ends the present algorithm.

On the other hand, when a multi-antenna service request signal is received from the host terminal, the terminal proceeds to step 403. In step 403, the terminal determines whether to approve a multi-antenna service request of the host terminal For example, the terminal determines whether to approve a multi-antenna service request of the host terminal, based on at least one of the service load, communication state, and battery state of the terminal

When not approving a multi-antenna service request of the host terminal, the terminal proceeds to step 413, where the terminal transmits denial information on the multi-antenna service request to the host terminal. When approving a multi-antenna service request of the host terminal, the terminal proceeds to step 405 where the terminal transmits approval information on the multi-antenna service request to the host terminal

In step 407, the terminal determines whether a signal of the host terminal is received from a serving BS. For example, when approving a multi-antenna service request of the host terminal, the terminal determines whether a signal of the host terminal is received through a communication link that is established with the serving BS in order to receive a signal of the host terminal.

When a signal of the host terminal is received from the serving BS, then in step 409, the terminal detects a signal transmitted through any one of the TX antennas of the serving BS, by applying a MIMO algorithm to the signal received from the serving BS. Herein, the TX antenna for detection of the signal by the terminal is determined by the host terminal

Thereafter, in step 411, the terminal transmits the signal detected in step 409 through the MIMO algorithm, to the host terminal through the short-range communication network. Herein, the terminal transmits its synchronization signal information to the host terminal together with the signal detected in step 409. The algorithm then ends.

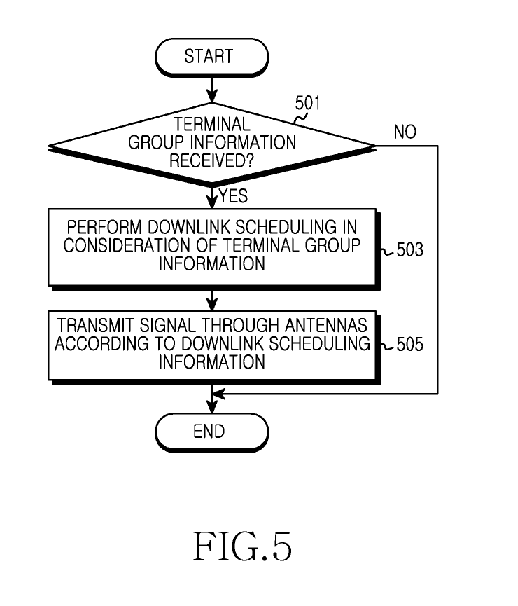

As described above, the host terminal may receive a signal according to a multi-antenna scheme by using one or more adjacent terminals capable of short-range communication. In this case, the base station may transmit a signal for a host to the host terminal and adjacent terminals included in a terminal group, as illustrated in FIG. 5.

FIG. 5 illustrates a process for transmitting a signal by a base station according to an exemplary embodiment of the present invention. In step 501, the base station determines whether terminal group information is received from a host terminal. For example, when a signal destined for a host terminal is generated, the base station establishes a communication link with the host terminal Herein, the base station determines whether terminal group information is received from the host terminal, while establishing a communication link with the host terminal.

When terminal group information is not received from the host terminal, the base station ends the present algorithm. In this case, the base station transmits a signal to the host terminal based on an antenna of the host terminal.

On the other hand, when terminal group information is received from the host terminal, the base station proceeds to step 503. In step 503, the base station performs downlink scheduling based on the terminal group information. For example, the base station recognizes the antennas of one or more adjacent terminals included in the terminal group, as an RX antenna of the host terminal Accordingly, the base station determines that the host terminal includes a plurality of RX antennas, and performs downlink scheduling as though the RX antennas were part of an actual antenna array in a MIMO system. Herein, in order to transmit a signal of the host terminal, the base station establishes a communication link with the host terminal and one or more adjacent terminals included in the terminal group.

Thereafter, in step 505, the base station transmits a signal of the host terminal through a plurality of TX antennas according to downlink scheduling information. The algorithm thereafter ends.

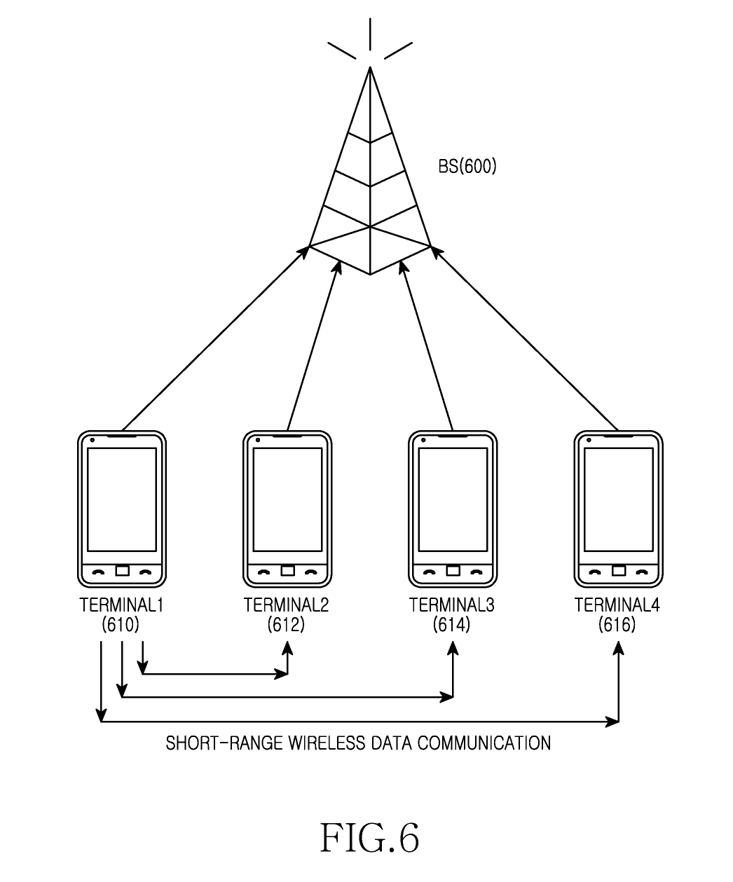

The wireless communication system may transmit an uplink signal through a multi-antenna scheme using a plurality of terminals, as illustrated in FIG. 6.

FIG. 6 illustrates a configuration for transmitting uplink (UL) data in a wireless communication system through a multi-antenna scheme according to an exemplary embodiment of the present invention. A first terminal 610 groups a second terminal 612, a third terminal 614, and a fourth terminal 616 into a terminal group for a multi-antenna service through a short-range communication network.

The first terminal 610 transmits a signal to the terminals 612, 614 and 616 included in the terminal group through the short-range communication network in order to transmit a signal to a base station 600 through a multi-antenna scheme. The short range communication scheme between the terminal 610 and the terminals 612, 614 and 616 is different from the communication scheme between the base station 100 and the terminals 610, 612, 614 and 616.

The second terminal 612, the third terminal 614, and the fourth terminal 616 acquire synchronization with the first terminal 610 by exchanging synchronization signals with the first terminal 610.

Thereafter, the second terminal 612, the third terminal 614, and the fourth terminal 616 each transmit a signal corresponding to a received signal from the first terminal 610 to the base station 600. At this point, the first terminal 610 also transmits a signal to the base station 600. For example, the first terminal 610 transmits transmission time point information (a TX timestamp) to the base station 600 to the terminals 612, 614 and 616. Accordingly, the synchronized terminals 610, 612, 614 and 616 can transmit a signal to the base station 600 at the same time point. Thus a virtual antenna array is established for uplink in which the four terminals each act as an antenna element of the array. Note that the distances between the transmitting terminals during the uplink transmissions are preferably held fixed at predetermined distances such as those in a typical antenna array interconnected with transmission lines.

The base station 600 detects a received uplink signal by applying a MIMO algorithm to signals received from the terminals 610, 612, 614 and 616 through a plurality of RX antennas.

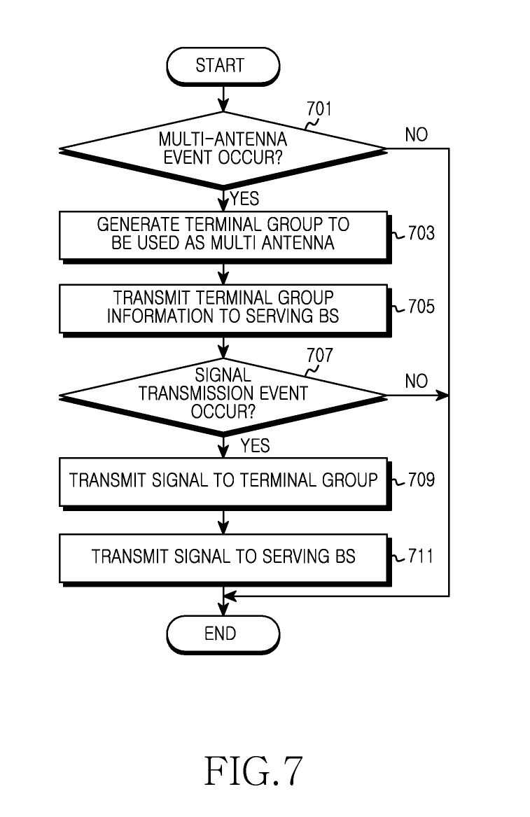

FIG. 7 illustrates a process for transmitting a signal by a host terminal through a multi-antenna scheme according to an exemplary embodiment of the present invention.

Referring to FIG. 7, in step 701, the host terminal determines whether a multi-antenna event occurs. For example, the host terminal determines whether a menu for a multi-antenna service is selected by a user. As another example, the host terminal determines whether an application program using a multi-antenna service is executed.

When a multi-antenna event does not occur, the host terminal determines that a multi-antenna service is not used. Accordingly, the host terminal ends the present algorithm.

On the other hand, when a multi-antenna event occurs, the host terminal proceeds to step 703. In step 703, the host terminal generates a terminal group for use as a TX antenna for a multi-antenna scheme. For example, when a multi-antenna event occurs, the host terminal uses a short-range communication network to detect whether there is an adjacent terminal to be used as a TX antenna. When detecting one or more adjacent terminals available as a TX antenna, the host terminal requests a multi-antenna service from the one or more adjacent terminals detected. Thereafter, the host terminal generates a terminal group so that one or more adjacent terminals accepting the multi-antenna service are used as a TX antenna. Herein, the adjacent terminals that can be used as a TX antenna by the host terminal include one or more terminals that are registered in the system so that antennas can be shared for a multi-antenna service, among the terminals located within a region capable of communicating signals with the host terminal through the short-range communication network.

In step 705, the host terminal transmits terminal group information to a serving BS. For example, the host terminal periodically transmits terminal group information to a serving BS. As another example, the host terminal may transmit terminal group information to a serving BS when a signal transmission/reception event occurs. Herein, the terminal group information includes identification information of adjacent terminals included in the terminal group.

In step 707, the host terminal determines whether a signal transmission event occurs. For example, the host terminal determines whether data to be transmitted to the serving BS is generated.

When a signal transmission event does not occur, the host terminal ends the present algorithm.

On the other hand, when a signal transmission occurs, the host terminal proceeds to step 709. In step 709, the host terminal transmits a signal destined for the serving BS to the adjacent terminals included in the terminal group through the short-range communication network. Herein, the host terminal transmits its synchronization signal and transmission time point information (TX timestamp) to the serving BS to the adjacent terminals included in the terminal group, together with the signal transmitted to the serving BS.

In step 711, the host terminal transmits a signal to the serving BS when the transmission time point to the serving BS arrives. The algorithm thereafter ends.

As described above, when a multi-antenna event occurs, the host terminal uses the short-range communication network to generate a terminal group for use as a TX antenna for a multi-antenna scheme. Thereafter, the host terminal may continuously update the terminal group by considering the states of adjacent terminals available as a TX antenna.

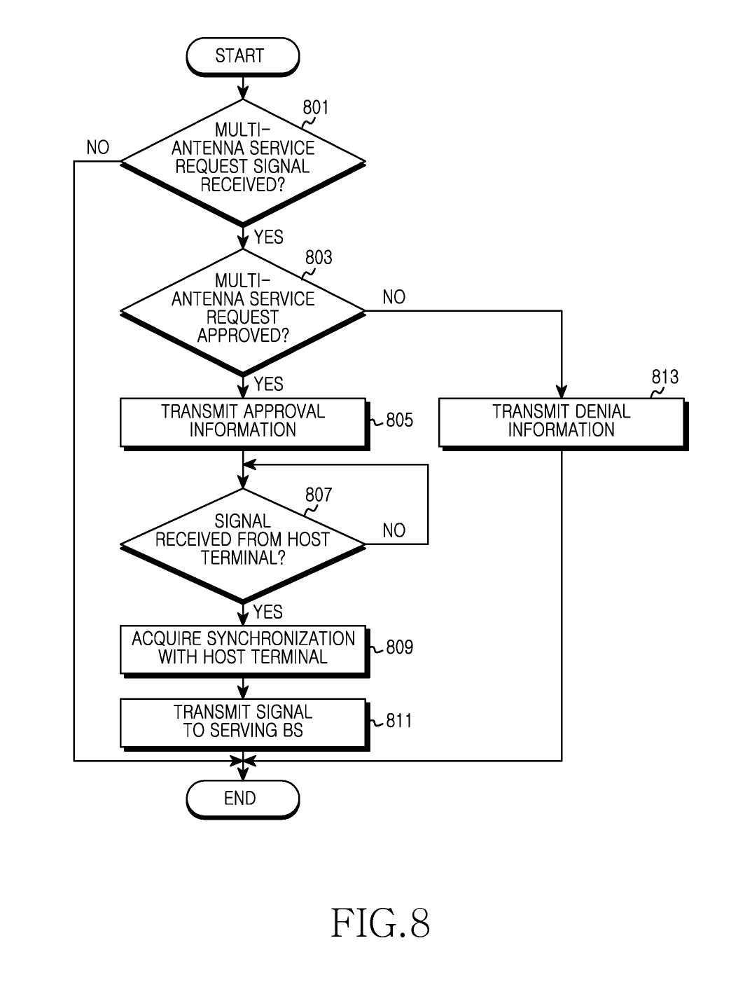

When the host terminal uses a multi-antenna scheme by using the signals received from the adjacent terminals included in the terminal group as described above, the adjacent terminal operates as illustrated in FIG. 8.

FIG. 8 illustrates a process for transmitting a signal of a host terminal by an adjacent terminal (hereafter, “the terminal”) according to an exemplary embodiment of the present invention.

In step 801, the terminal determines whether a multi-antenna service request signal is received from the host terminal through a short-range communication network. Herein, the host terminal means any terminal requesting a multi-antenna service, among the terminals that are registered in the system so that antennas can be shared for a multi-antenna service.

When a multi-antenna service request signal is not received from the host terminal, the terminal determines that a multi-antenna service is not provided. Accordingly, the terminal ends the present algorithm.

On the other hand, when a multi-antenna service request signal is received from the host terminal, the terminal proceeds to step 803. In step 803, the terminal determines whether to approve a multi-antenna service request of the host terminal For example, the terminal determines whether to approve a multi-antenna service request of the host terminal, based on at least one of the service load, communication state, and battery state of the terminal.

When not approving a multi-antenna service request of the host terminal, the terminal proceeds to step 813. In step 813, the terminal transmits denial information on the multi-antenna service request to the host terminal.

When approving a multi-antenna service request of the host terminal, the terminal proceeds to step 805. In step 805, the terminal transmits approval information on the multi-antenna service request to the host terminal.

In step 807, the terminal determines whether a signal destined for a serving BS is received from the host terminal through the short-range communication network.

When a signal destined for the serving BS is received from the host terminal, the terminal proceeds to step 809. In step 809, the terminal acquires synchronization with the host terminal For example, the terminal acquires synchronization with the host terminal by using a synchronization signal included in the signal received from the host terminal.

In step 811, when a transmission time point to the serving BS received from the host terminal arrives, the terminal transmits a signal that is destined for the serving BS and is received from the host terminal, to the serving BS. For example, when approving a multi-antenna service request of the host terminal, the terminal transmits a signal to the serving BS through a communication link that is established with the serving BS in order to transmit a signal of the host terminal to the serving BS. Thereafter the present algorithm ends.

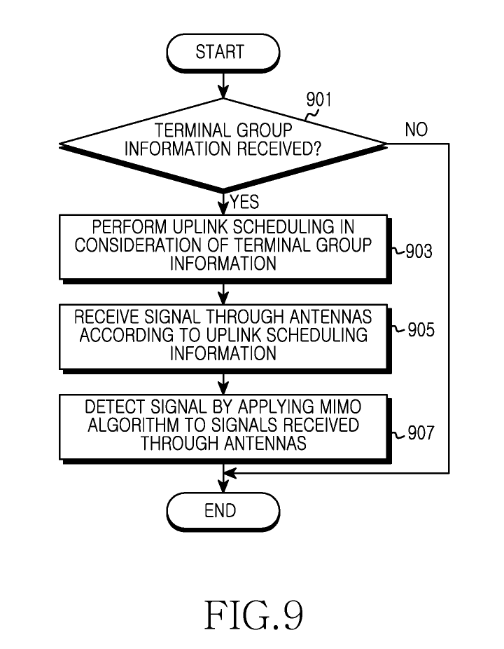

As described above, the host terminal may transmit a signal according to a multi-antenna scheme by using one or more adjacent terminals capable of short-range communication. In this case, the base station may receive a signal from the host terminal and adjacent terminals included in a terminal group, as illustrated in FIG. 9.

FIG. 9 illustrates a process for receiving a signal by a base station according to an exemplary embodiment of the present invention. In step 901, the base station determines whether terminal group information is received from a host terminal. For example, when a signal destined for a host terminal is generated, the base station establishes a communication link with the host terminal. Herein, the base station determines whether terminal group information is received from the host terminal, while establishing a communication link with the host terminal.

When terminal group information is not received from the host terminal, the base station ends the present algorithm.

On the other hand, when terminal group information is received from the host terminal, the base station proceeds to step 903. In step 903, the base station performs uplink scheduling based on the terminal group information. For example, the base station recognizes the antennas of one or more adjacent terminals included in the terminal group, as a TX antenna of the host terminal Accordingly, the base station determines that the host terminal includes a plurality of TX antennas, and performs uplink scheduling. In this case, in order to receive a signal from the host terminal and one or more adjacent terminals included in the terminal group, the base station establishes a communication link with the host terminal and the respective adjacent terminals included in the terminal group.

Thereafter, in step 905, the base station receives signals transmitted by the host terminal and one or more adjacent terminals included in terminal group, through a plurality of RX antennas according to uplink scheduling information.

Thereafter, in step 907, the base station may detect a received signal by applying a MIMO algorithm to the signals received through the plurality of RX antennas. Thereafter, the present algorithm ends.

Hereinafter, a description will be given of a configuration of a terminal for providing a multi-antenna scheme by using one or more adjacent terminals.

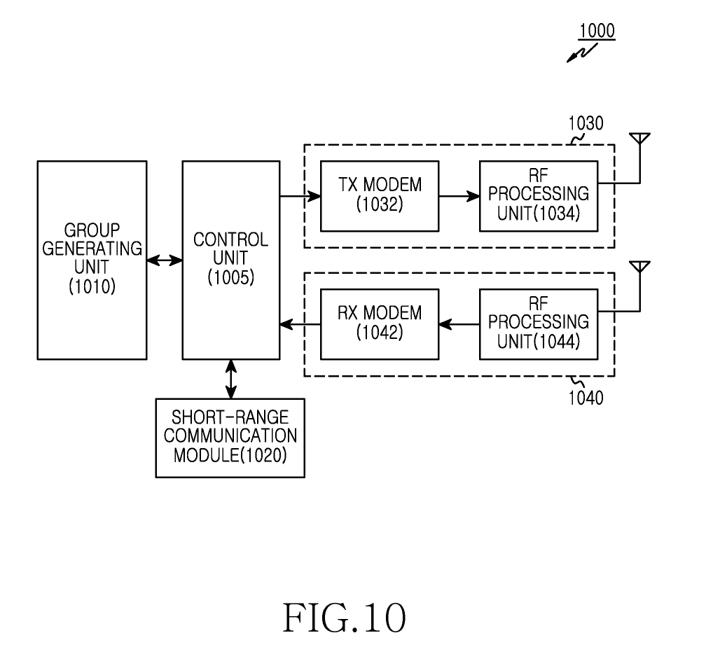

FIG. 10 illustrates a block configuration of a terminal, 1000, according to the present invention. The terminal 1000 includes a control unit 1005, a group generating unit 1010, a short-range communication module 1020, a transmitting unit 1030, and a receiving unit 1040.

The control unit 1000 controls an overall operation of the terminal Control unit 1000 further controls the group generating unit 1010 to generate a terminal group for use as at least one additional antenna according to a multi-antenna scheme. In this case, the control unit 1005 controls an operation to transmit information on the terminal group generated by the group generating unit 1010 to a serving BS.

The control unit 1005 controls operations to receive a signal according to a multi-antenna scheme by using adjacent terminals included in the terminal group generated by the group generating unit 1010. For example, as illustrated in FIG. 2, the control unit 1005 detects a received signal by using a signal received through the receiving unit 1040 and signals received through the short-range communication module 1020 from the adjacent terminals included in the terminal group. In this case, the control unit 1005 acquires synchronization with the adjacent terminals by exchanging synchronization signals through the short-range communication module 1020 from the adjacent terminals included in the terminal group.

The control unit 1005 controls operations to transmit a signal according to a multi-antenna scheme by using the adjacent terminals included in the terminal group generated by the group generating unit 1010. For example, as illustrated in FIG. 7, the control unit 1005controls transmission of a signal to a serving BS by using the transmitting unit 1030 and the terminal group generated by the group generating unit 1010.

Under the control of the control unit 1005, the group generating unit 1010 generates a terminal group for use as at least one additional antenna for a multi-antenna service. For example, the group generating unit 1010 uses the short-range communication module 1020 to detect whether there is/are one or more adjacent terminals to be used as an additional antenna for a multi-antenna service. Thereafter, the group generating unit 1010 groups one or more adjacent terminals accepting a multi-antenna service request, among the one or more adjacent terminals detected, into a terminal group. Herein, the adjacent terminals include one or more terminals that are registered in the system so that antennas can be shared for a multi-antenna service, among the terminals located within a region capable of communicating signals with a host terminal through a short-range communication network.

The short-range communication module 1020 communicates with the adjacent terminal through the short-range communication network. Herein, the short-range communication network may operate in accordance with, e.g., wireless LAN, WiGig, Bluetooth, UWB or any other suitable protocol.

The receiving unit 1030 includes an RX modem 1032 and a radio frequency (RF) processing unit 1034. The RF processing unit 1034 converts an RF signal received through an RX antenna into a baseband signal, and transmits the same to the RX modem 1032. The RX modem 1032 converts a baseband signal received from the RF processing unit 1034 into a digital signal prior to demodulation and decoding.

The transmitting unit 1040 includes a TX modem 1042 and an RF processing unit 1044.

The TX modem 1042 encodes and modulates a signal to be transmitted through a TX antenna, and converts the modulated signal into an analog signal prior to output. The RF processing unit 1044 converts a baseband analog signal received from the TX modem 1042 into an RF signal, and transmits the same through a TX antenna to the outside.

In the above embodiment, when the terminal operates as a host terminal, the control unit 1005controls operations to provide a multi-antenna service by using the terminal group generated by the group generating unit 1010.

In another exemplary embodiment, when the terminal operates as an additional antenna for a multi-antenna service of a host terminal, the control unit 1005 controls the terminal to provide a multi-antenna service of the host terminal For example, in the case of downlink, the control unit 1005 controls operations such that a signal of the host terminal received from the serving BS is transmitted to the host terminal through the short-range communication module 1020, as illustrated in FIG. 3 or 4. As another example, in the case of uplink, the control unit 1005 controls uplink operations such that a signal received from the host terminal through the short-range communication module 1020 is transmitted to the serving BS, as illustrated in FIG. 8.

In addition, when the host terminal requests a multi-antenna service through the short-range communication module 1020, the control unit 1005 determines whether to approve the multi-antenna service request of the host terminal, based on at least one of the service load, communication state, and battery state of the terminal.

In the above embodiment, the terminal uses a TX antenna and an RX antenna separately.

In another embodiment, the terminal may transmit/receive signals through one antenna.

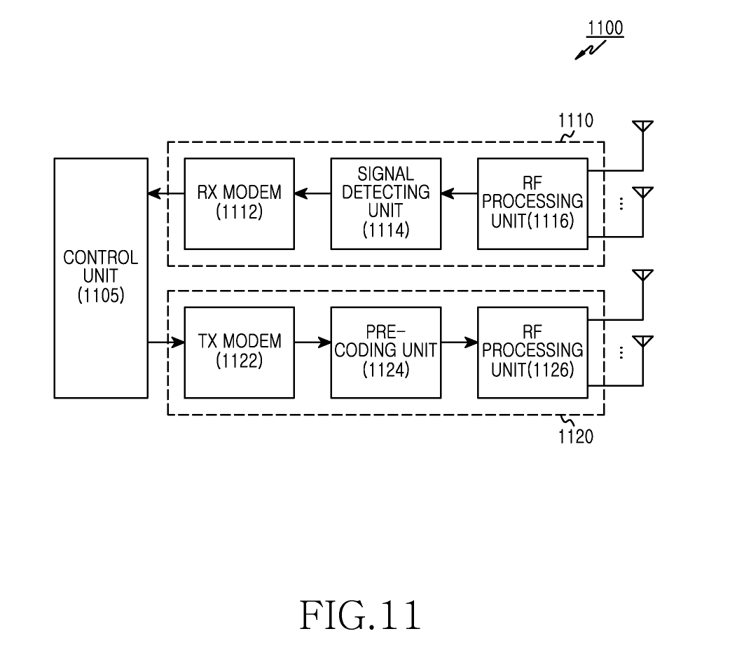

FIG. 11 illustrates a block configuration of a base station, 1100, according to the present invention. Base station includes a control unit 1105, a receiving unit 1110, and a transmitting unit 1120.

The control unit 1105 controls an overall operation of the base station.

The control unit 1105 further controls transmitting a signal through a plurality of TX antennas. For example, when terminal group information is received from a host terminal, the control unit 1105 recognizes antennas of one or more adjacent terminals included in a terminal group as an RX antenna of the host terminal, as illustrated in FIG. 5. Accordingly, the control unit 1105 determines that the host terminal includes a plurality of RX antennas, and performs control to transmit a signal through a plurality of TX antennas. In this case, the control unit 1105 establishes a communication link with each adjacent terminal so that one or more adjacent terminals included in the terminal group can receive a signal of the host terminal

The control unit 1105 performs control to receive a signal through a plurality of RX antennas. For example, when terminal group information is received from a host terminal, the control unit 1105 recognizes antennas of one or more adjacent terminals included in a terminal group as a TX antenna of the host terminal, as illustrated in FIG. 9. Accordingly, the control unit 1105 determines that the host terminal includes a plurality of TX antennas, and performs control to receive a signal through a plurality of RX antennas. In this case, the control unit 1105 establishes a communication link with each adjacent terminal so that signals can be received from the host terminal and one or more adjacent terminals included in the terminal group.

The receiving unit 1110 includes an RX modem 1112, a signal detecting unit 1114, and an RF processing unit 1116.

The RF processing unit 1116 converts an RF signal received through each RX antenna into a baseband signal. Herein, the receiving unit 1110 may include RF processing units 1116 as many as the number of RX antennas.

The signal detecting unit 1114 detects a received signal by applying a MIMO algorithm to a plurality of baseband signals received from the RF processing unit 1116.

The RX modem 1112 demodulates and decodes the received signal detected by the signal detecting unit 1114.

The transmitting unit 1120 includes a TX modem 1122, a pre-coding unit 1124, and an RF processing unit 1126.

The TX modem 1122 encodes and modulates signals to be transmitted through TX antennas, and converts the modulated signals into analog signals prior to output.

The pre-coding unit 1124 pre-codes signals received from the TX modem 1122, prior to transmission trough the respective TX antennas.

The RF processing unit 1126 converts the pre-coded signals received from the pre-coding unit 1124 into RF signals, and transmits the RF signals through the respective TX antennas to the outside. Herein, the transmitting unit 1120 may include RF processing units 1126 as many as the number of TX antennas.

In the above embodiment, the terminal uses a TX antenna and an RX antenna separately.

In another embodiment, the terminal may transmit/receive signals through one antenna.

As described above, the present invention provides a multi-antenna scheme in a wireless communication system by using a plurality of terminals, thereby making it possible to increase a data transmission rate in a terminal including a small number of antennas and to achieve a multi-antenna transmission gain such as a diversity gain.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While examples of the invention have been shown and described with reference to certain exemplary embodiments thereof, it will be understood by those skilled in the art that various changes in form and details may be made therein without departing from the spirit and scope of the invention as defined by the appended claims. Therefore, the scope of the invention is defined not by the detailed description herein but by the appended claims and equivalents thereof, and all differences within the scope will be construed as being included in the present invention.

What is claimed is:

1. A method operative in a mobile terminal with one or more antennas, comprising:
receiving a first signal from a base station;
receiving at least one second signal through a short-range communication network from at least one adjacent terminal, the at least one second signal being representative of the first signal transmitted from the base station as received at the at least one adjacent terminal; and
detecting a received signal as an antenna array signal on the basis of the first and at least one second signals,
wherein the at least one adjacent terminal previously receives the at least one second signal transmitted from the base station based on information from the mobile terminal of a group in which the mobile terminal and the at least one adjacent terminal are grouped.

2. The method of claim 1, wherein establishing the terminal group comprising the following steps is further comprised:
detecting one or more adjacent terminals available as a multi antenna among one or more terminals located within a short-range communication area;
requesting a multi-antenna service from the one or more adjacent terminals; and
establishing the terminal group including one or more adjacent terminals accepting the multi-antenna service request among the one or more adjacent terminals from which the multi-antenna service is requested.

3. The method of claim 1, wherein detecting the received signal comprises:
acquiring synchronization with the at least one adjacent terminal included in the terminal group; and
detecting the received signal by applying a multiple-input multiple-output (MIMO) algorithm to the first and at least one second signals.

4. The method of claim 1, wherein detecting the received signal comprises:
detecting a signal of any one of transmission (TX) antennas of the base station by applying a MIMO algorithm to the first signal received from the base station;
acquiring synchronization with the at least one adjacent terminal; and
combining the detected signal and the at least one second signal into one received composite signal.

5. The method of claim 1, further comprising transmitting information of the terminal group to the base station, wherein the information on the terminal group includes identification information on the at least one adjacent terminal included in the terminal group.

6. An apparatus for use in a mobile terminal with one or more antennas, comprising:
a short-range communication module configured to communicate with at least one adjacent terminal through a short-range communication network;
a receiving unit configured to receive a first signal from a base station;
a transmitting unit configured to transmit a signal to the base station; and
a control unit configured to detect a received signal on the basis of a first signal received from the base station through the receiving unit and at least one second signal received through the short-range communication module from the at least one adjacent terminal,
wherein the at least one adjacent terminal receives the at least one second signal transmitted from the base station based on information from the mobile terminal of a group in which the mobile terminal and the at least one adjacent terminal are grouped.

7. The apparatus of claim 6, further comprising,
a group generating unit configured to establish a terminal group including the at least one adjacent terminal by using the short-range communication module,
wherein the group generating unit detects one or more adjacent terminals available as a multi antenna among one or more terminals located within a short-range communication area, requests a multi-antenna service from the one or more adjacent terminals, and generates the terminal group including one or more adjacent terminals accepting the multi-antenna service request.

8. The apparatus of claim 6, wherein the control unit acquires synchronization with the at least one adjacent terminal included in the terminal group, and detects the received signal by applying a MIMO algorithm to the first signal and the at least one second signal.

9. The apparatus of claim 6, wherein the control unit detects a signal of any one of TX antennas of the base station by applying a MIMO algorithm to the signal received from the base station, and combines the detected signal and the second signal into one received composite signal.

10. The apparatus of claim 6, wherein the control unit transmits the information on the terminal group, including identification information on the at least one adjacent terminal included in the terminal group, to the base station through the transmitting unit.

11. A method for transmitting a signal by a mobile terminal with one or more antennas, comprising:
establishing a terminal group including at least one adjacent terminal;
transmitting information on the terminal group to a base station;
transmitting a second signal destined for the base station through a short-range communication network to the at least one adjacent terminal; and
transmitting a first signal to the base station when a signal transmission time point to the base station arrives.

12. The method of claim 11, wherein establishing the terminal group comprises:
detecting one or more adjacent terminals available as a multi antenna among one or more terminals located within a short-range communication area;
requesting a multi-antenna service from the one or more adjacent terminals detected; and
establishing the terminal group including one or more adjacent terminals accepting the multi-antenna service request among the one or more adjacent terminals from which the multi-antenna service is requested.

13. The method of claim 11, wherein transmitting the signal to the at least one adjacent terminal comprises transmitting the signal destined for the base station and signal transmission time point information through the short-range communication network to the at least one adjacent terminal.

14. The method of claim 11, wherein the information on the terminal group includes identification information on the at least one adjacent terminal included in the terminal group.

15. An apparatus for use in a mobile terminal with one or more antennas, comprising:
a short-range communication module configured to communicate with at least one adjacent terminal through a short-range communication network;
a receiving unit configured to receive a receive signal from the base station;
a transmitting unit configured to transmit a first signal to a base station;
a group generating unit configured to establish a terminal group including the at least one adjacent terminal by using the short-range communication module; and
a control unit configured to transmit information on the terminal group to the base station through the transmitting unit, transmit a second signal destined for the base station through the short-range communication network to the at least one adjacent terminal included in the terminal group, and transmit the first signal to the base station when a signal transmission time point to the base station arrives.

16. The apparatus of claim 15, wherein the group generating unit detects one or more adjacent terminals available as a multi antenna among one or more terminals located within a short-range communication area, requests a multi-antenna service from the one or more adjacent terminals, and generates the terminal group including one or more adjacent terminals accepting the multi-antenna service request.

17. The apparatus of claim 15, wherein the control unit uses the short-range communication module to transmit the second signal destined for the base station and signal transmission time point information to the one or more adjacent terminals included in the terminal group.

18. The apparatus of claim 15, wherein the control unit transmits the information on the terminal group, including identification information on the one or more adjacent terminals included in the terminal group, to the base station through the transmitting unit.

19. A method for transmitting a signal by a mobile terminal with one or more antennas, comprising:
acquiring synchronization with a first terminal;
receiving a signal destined for a base station from the first terminal through a short-range communication network; and
transmitting the signal that is destined for the base station and is received from the first terminal to the base station, when a signal transmission time point to the base station arrives.

20. The method of claim 19, further comprising:
when the first terminal requests a multi-antenna service, determining whether to approve the multi-antenna service request of the first terminal based on at least one of a service load, a communication state, and a battery state; and
when the multi-antenna service request of the first terminal is approved, determining whether the signal destined for the base station is received from the first terminal through the short-range communication network.

21. An apparatus for transmitting a signal by a mobile terminal with one or more antennas, comprising:
a short-range communication module configured to communicate with at least one adjacent terminal through a short-range communication network;
a transmitting unit configured to transmit a signal to a base station; and
a control unit configured to acquire synchronization with a first terminal, receive a signal destined for a base station from the first terminal by using the short-range communication module, and transmit the signal that is destined for the base station and is received from the first terminal to the base station by using the transmitting unit, when a signal transmission time point to the base station arrives.

22. The apparatus of claim 21, wherein when the first terminal requests a multi-antenna service, the control unit determines whether to approve the multi-antenna service request of the first terminal based on at least one of a service load, a communication state, and a battery state.
